(19) United States
(12) Patent Application Publication
(10) Pub. No.: US 2017/0157850 A1
(43) Pub. Date: Jun. 8, 2017

(54) MULTI-WAVELENGTH LASER RAPID PROTOTYPING SYSTEM AND METHOD

(71) Applicant: Chongqing Institute of Green and Intelligent Technology, Chinese Academy of Sciences, Chongqing (CN)

(72) Inventors: Xuanming DUAN, Chongqing (CN); Jie LIU, Chongqing (CN); Hongzhong CAO, Chongqing (CN); Shuqian FAN, Chongqing (CN); Meiling ZHENG, Chongqing (CN); Jiquan LIU, Chongqing (CN)

(21) Appl. No.: 15/437,103

(22) Filed: Feb. 20, 2017

Related U.S. Application Data
(63) Continuation of application No. PCT/CN2015/087237, filed on Aug. 17, 2015.

(30) Foreign Application Priority Data
Aug. 18, 2014 (CN) 201410406399.3

(51) Int. Cl. B29C 67/00; B28B 1/00; B33Y 10/00; B33Y 30/00; B23K 26/70; B28B 17/00; B23K 26/06; B23K 26/082; B23K 26/342; B22F 3/105; B33Y 50/02

(52) U.S. Cl. CPC B29C 67/0077; B22F 3/105; B28B 1/001; B33Y 10/00; B33Y 30/00; B33Y 50/02; B29C 67/0085; B29C 67/0088; B28B 17/0081; B23K 26/0604; B23K 26/0648; B23K 26/082; B23K 26/342; B23K 26/705

(57) ABSTRACT

This invention discloses a multi-wavelength selective laser rapid prototyping system comprising laser light sources, laser transmission and control components, laser focusing and scanning components, manufacturing chamber, powder feeding components, powder laying components, gas circulation control components, real-time monitoring components, lifting components, powder recovery components, and computer. Said laser light source comprises a first laser source for providing a first wavelength laser beam and a second laser source for providing a second wavelength laser beam, or a laser source for providing both the first and second wavelength laser beams. Adoption of a short wave laser beam in the system is beneficial to improve the manufacturing resolution and precision. At the same time a superposed long wavelength laser beam is adopted to ensure the preheating and subsequent heat treatment. Thermal stress of the manufactured structure is reduced. Manufacturing efficiency is further improved. A multi-wavelength selective laser rapid prototyping method is also provided.

### FIELD OF THE INVENTION

The present invention relates to laser 3D printing technique, and more particularly to a multi-wavelength selective laser rapid prototyping system and method.

### DESCRIPTION OF THE RELATED ART

3D printing is a typically digital and green intelligent manufacturing technology, in which three-dimensional complicated parts are directly fabricated layer by layer under computer control with the designed digital model. It has a wide range of applications in aerospace, defense industry, automobile, mold, consumer electronics, biomedical and other fields.

Selective laser rapid prototyping is a high-precision 3D printing technology that can be used for the manufacture of parts with high precision and high complexity. At present, the selective laser rapid prototyping mainly includes selective laser sintering and selective laser melting. The typical energy sources for selective laser rapid prototyping are the 10.6 μm CO₂ laser and the fiber laser or solid laser with wavelength of about 1.08 μm. In the rapid prototyping manufacturing process, the materials in the laser scanning area are fast heated by laser and undergo a fast cooling process after the laser passed. It will result in a large thermal stress in the manufactured structure, and cause structural deformation or even fracture. By adding the heating and temperature holding unit in the manufacturing chamber, the thermal stress inside the manufactured structures can be reduced, and the utilization rate of the laser energy can also be improved. However, high temperature in the chamber can also damage the powders outside the laser irradiated area, and reduce recovery utilization rate of powders. Therefore, the manufacturing cost will increase, in order to reduce the thermal stress inside the manufactured structure while not destroy the materials outside the laser irradiated area, F. Abe et al. demonstrated selective laser melting metallic structures by using a 1.064 μm Nd: YAG laser with a 10.6 μm CO₂ laser for manufactured structure reheating. By adjusting the distance between the two lasers in the manufacturing plane, it is proved that the thermal stress can be reduced by utilizing a CO₂ laser to reheat the manufactured structures, see F. Abe et al., Journal of Materials Processing Technology, 2001 111, 210-213. Shi Yusheng et al. proposed a method for selective laser melting rapid prototyping by using three laser beams. The first laser beam of wavelength greater than 10 μm is used to preheat the powders, the second laser beam of wavelength less than 1.1 μm is used to melt the powders and form the structure, and the third laser beam of wavelength greater than 10 μm is used for subsequent heat treatment. This method can reduce the thermal stress of the manufactured structures, see Shi Yusheng et al., a selective laser rapid prototyping method for metal powders by using three-beam, laser composite scanning (Publication No. CN101607311A, Publication Date Dec. 23, 2009). However, three laser beams scanned one after one in this method, which need a complicated control procedure and more manufacturing time. A lot of heat energy in preheated powders provided by the first laser beam had dispersed before scanned by the second laser. Therefore, tire energy utilization efficiency was reduced, Jan Wilkes et at proposed a protocol for ceramic structure manufacturing. In this protocol, a CO₂ laser was projected at 20 mm×30 mm area in manufacturing plane, and powders in projected area was selectively melted by using a Nd: YAG laser. The result shows that the thermal stress in the manufactured ceramic structure can be reduced by rising CO₂ laser preheating, see Jan Wilkes et al., Rapid Prototyping Journal, 2013,19, 51-57. However, the preheating COS laser need to be projected at a large area for a long time in the method. The energy utilization rate of the preheating laser is low and it may also result in the waste of materials in the irradiated area. Therefore, it is an urgent need to develop a new technology to reduce the thermal stress and the damage to the powders in unmelted area while improving the manufacturing efficiency and precision.

### SUMMARY OF THE INVENTION

In view of the above, it is an object of the invention to provide a high precision, high efficiency and high performance coaxial multi-wavelength selective laser rapid prototyping system and method. The selective laser melting or sintering is carried out by using a focused short wavelength laser beam, and the preheating and subsequent heat treatment is carried out by using a focused long wavelength laser which is coaxial with the short wavelength laser. The short wavelength laser beam has a small spot size and high photon energy which are helpful to improve the manufacturing precision. The focusing spot size of the long wavelength laser beam is larger than that of the short wavelength laser, which ensures to realize the preheating and subsequent heat treatment. This method could further improve the laser manufacturing efficiency and reduce the thermal stress in the structure.

It is an object of the present invention to provide a multi-wavelength selective laser rapid prototyping system which is realized by the following technical solution:

A multi-wavelength selective laser rapid prototyping system, comprising the laser light sources, laser transmission and control components, laser focusing and scanning components, manufacturing chamber, powder feeding components, powder laying components, gas circulation control components, real-time monitoring components, lifting components, powder recovery components, and computer, wherein

said laser light source comprises a first laser source for providing a first wavelength laser beam and a second laser source for providing a second wavelength laser beam, or a laser source for providing both the first and second wavelength laser beams;

said laser the focusing and scanning components includes two laser focusing lenses for focusing the first wavelength laser beam and the second wavelength laser beam respectively, a dichroic mirror for combining the first wavelength laser beam and the second wavelength laser beam into a combined coaxial laser beam propagating in the same direction, and a two-dimensional galvanometer scanner for realizing laser scanning in a manufacturing plane; and

said real-time monitoring components includes an imaging unit for monitoring the morphology of the molten pool and a temperature monitoring unit for monitoring the temperature and temperature field distribution of the molten pool.

Further, the wavelength range of the aforesaid, first wavelength laser beam is from 200 nm to 1.1 μm, the wavelength range of the aforesaid second wavelength laser beam is from 700 nm to 10.6 μm; and the first wavelength laser beam and the second wavelength laser are continuous, pulsed or quasi-continuous laser.

Further, said the laser transmission and control, components includes reflectors for changing laser beam direction, beam expanders for realizing the first and second wavelength laser beams expansion respectively, laser shatters and laser attenuators for controlling the power of the first wavelength laser beam and the second wavelength laser beam respectively.

Further, said manufacturing chamber includes a chamber door for taking out manufactured structures, an observation window for visual observation, a light window for real-time monitoring, a laser incidence window for laser input, and a gas flow port for gas circulation and atmosphere control.

Further, a substrate is arranged in the aforesaid manufacturing chamber, and it is connected with the lifting components to realize the lifting movement; the bottom of the manufacturing chamber is further provided with a channel for recovering the powder, wherein a port of the channel is connected with the powder recovery component.

Further, said imaging unit includes a CCD for image acquisition and a monitor for image presentation.

Further, said temperature monitoring unit comprises an infrared thermal imager for infrared thermal image acquisition and a data acquisition card for acquiring data of the thermal imager and inputting the data to the computer.

It is another object of the present invention to provide a multi-wavelength selective laser rapid prototyping method, wherein said method comprises:

1) building a geometric model by using a computer drawing software, slicing the model, and planning the scanning path;

2) extracting air in manufacturing chamber and Ming the chamber with protective gas according to need;

3) preheating and feeding powders by the powder feeding components, and laying a layer of powders on substrate by using the powder laying components;

4) simultaneously scanning the laid powders in planned scanning path by using the focused first and second wavelength laser beam so that powders are melted to form a single-layer structure;

5) lowering the substrate by one layer, and repeating the process of powder laying and selective laser scanning until the manufacturing process of the structure in designed geometric model is completed; and

6) cleaning the unmet ted metal powders and taking out the manufactured structure.

Further, said powder has a size from 10 nm to 200 μm.

Further, said powders include metal powders, plastic powders, ceramic powders, coated sand powders, polymer powders.

The beneficial technical effects of the invention are as follows:

1. According to the system and method of the invention, materials melting for forming structure is carried out by a short wavelength laser, thus the manufacturing resolution and precision can be improved.

2. According to the system and method of the invention, a dual-wavelength laser coaxial simultaneous scanning is carried out, thus the manufacturing efficiency can also be improved.

3. According to the system and method of the present invention, the preheating and subsequent heat treatment can be carried out by using a long wavelength laser, thus the thermal stresses of the manufactured structure can be reduced. No damage is generated to powders in the unmelted area by means of a selective preheating, thus the waste sod consumption of powers can also be reduced.

### BRIEF DESCRIPTION OF THE DRAWINGS

The present invention will now be described in further detail with accompanying drawings to make the objects, the technical solutions and the advantages of this invent more apparent, wherein,

FIG. 1 is the schematic view of system with two laser sources according to the present invention;

FIG. 2 is the schematic view of system with one laser source according to the present invention;

FIG. 3 is a flow chart of multi-wavelength selective laser rapid prototyping method according to the present invention; and

FIG. 4 is a schematic view of laser focal spots in the present invention.

### DESCRIPTION OF THE EMBODIMENTS

Exemplary embodiments of the present invention will be described below. It should be understood that the preferred exemplary embodiments are merely to illustrate the invention and don't limit the scope of the invention.

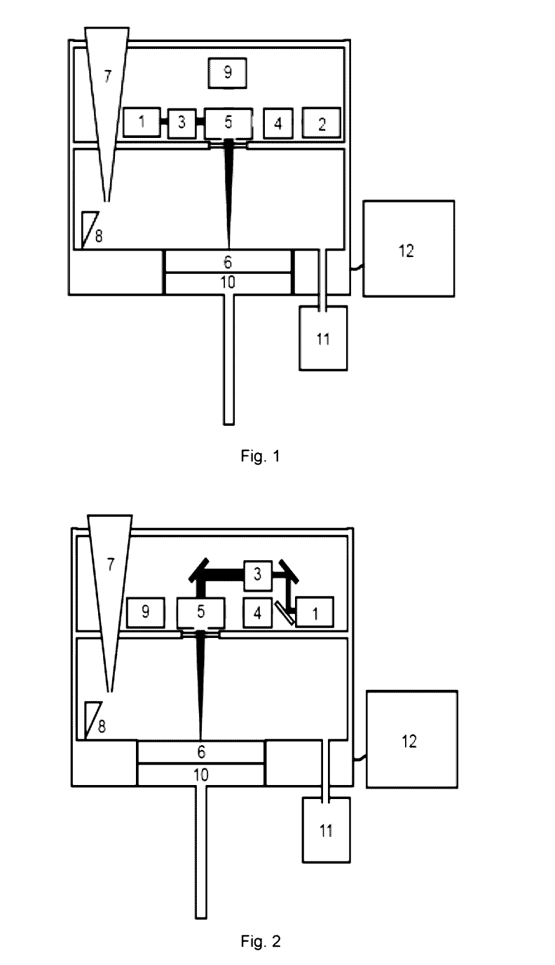

FIG. 1 is the schematic view of system with two laser sources according to the present invention. As shown in the figure, the system comprise the first laser source 1 and the laser transmission and control components 3 for the first laser beam, the second laser source 2 and the laser transmission and control components 4 for the second laser beam, the laser focusing and scanning components 5, the substrate 6, the powder feeding components 7, the powder laying components 8, the real-time monitoring components 9; the lifting components 10; the powder recovery components 11, and the computer 12.

The first laser source 1 and the second laser source 2 are used to supply laser beams of different wavelengths respectively, and the laser beams outputted by the first and second laser sources are switched on or off, expanded, and power-modulated by using the laser transmission and control components 3 and 4.

Said the laser focusing and scanning components 5 is used to realize the focusing and combination of the first and second wavelength laser beams, and scanning in a manufacturing plane.

The bottom of aforesaid manufacturing chamber has a substrate 6. On the top of the chamber, the powder feeding components 7 is provided for powder delivery and pretreatment. The powder laying components 8 for laying powders onto the substrate 6 is below the powder feeding components 7.

The real-time monitoring components 9 comprises an imaging unit for monitoring the morphology of the molten pool and a temperature monitoring unit for monitoring the temperature and temperature field distribution of the molten pool, wherein the imaging unit includes a CCD for image acquisition and a monitor for image presentation, and the temperature monitoring unit comprises an infrared thermal imager for infrared thermal image acquisition and a data acquisition card for acquiring data of the thermal imager and input ting the data to the computer.

The substrate 6 is connected to the lifting components 10, and the lifting movement of the substrate 6 is achieved by the lifting components 10.

The bottom of the manufacturing chamber is also provided with a channel for recovering the powder, and a port of the channel is connected with the powder recovery components 11 for recovering the unmelted powders.

The computer 12 is connected to the laser transmission and control components 3 and 4, the laser focusing and scanning components 5, the substrate 6, the powder feeding components 7, the powder laying component 8, the real-time monitoring component 9, the lifting components 10, and the powder recovery components 11. It is used to control the switching of lasers, the laser power, the changing of focal length, the scanning speed, the lifting of the substrate, the feeding and laying of powders, the molten pool image, the temperature data acquisition, and the powder recovery.

FIG. 2 is the schematic view of system with one laser source according to the present invention. As shown in the figure, the system comprises a laser source 1 for providing the first and second wavelength laser beams, the dichroic mirror for separating two wavelength laser beams, the reflector for laser beam deflection, the laser transmission control components 3 and 4 for the first and second wavelength laser beams, the laser focusing and scanning components 5, the substrate 6, the powder feeding components 7, the powder laying components 8, the real-time monitoring components 9; the lifting components 10; the powder recovery components 11 and the computer 12.

The first and the second wavelength laser beams outputted by the laser source 1 are switched on or oil, expanded, and power-modulated by using the laser transmission and control components 3 and 4.

Said the laser focusing and scanning components 5 is used to realize the focusing and combination of the first and second wavelength laser beams, and scanning in a manufacturing plane.

The bottom of aforesaid manufacturing chamber has a substrate 6. On the top of the chamber, the powder feeding components 7 is provided for powder delivery and pretreatment The powder laying components 8 for laying powders onto the substrate 6 is below the powder feeding components 7.

The real-time monitoring components 9 comprises an imaging unit for monitoring the morphology of the molten pool and a temperature monitoring unit for monitoring the temperature and temperature field distribution of the molten pool, wherein the imaging unit includes a CCD for image acquisition and a monitor for image presentation, and the temperature monitoring unit comprises an infrared thermal imager for infrared thermal image acquisition and a data acquisition card for acquiring data of the thermal imager and inputting the data to the computer.

The substrate 6 is connected to the lifting components 10, and the lifting movement of the substrate 6 is achieved by the lifting components 10.

The bottom of the manufacturing chamber is also provided with a channel for recovering the powder, and a port of the channel is connected with the powder recovery components 11 for recovering the unmelted powders.

The computer 12 is connected to the laser transmission and control components 3 and 4, the laser focusing and scanning components 5, the substrate 6, the powder feeding components 7, the powder laying component 8, the real-time monitoring component 9, the lifting components 10, and the powder recovery components 11. It is used to control the switching of lasers, the laser power, the changing of focal length, the scanning speed, the lifting of the substrate, the feeding and laying of powders, the molten pool image, the temperature data acquisition, and the powder recovery.

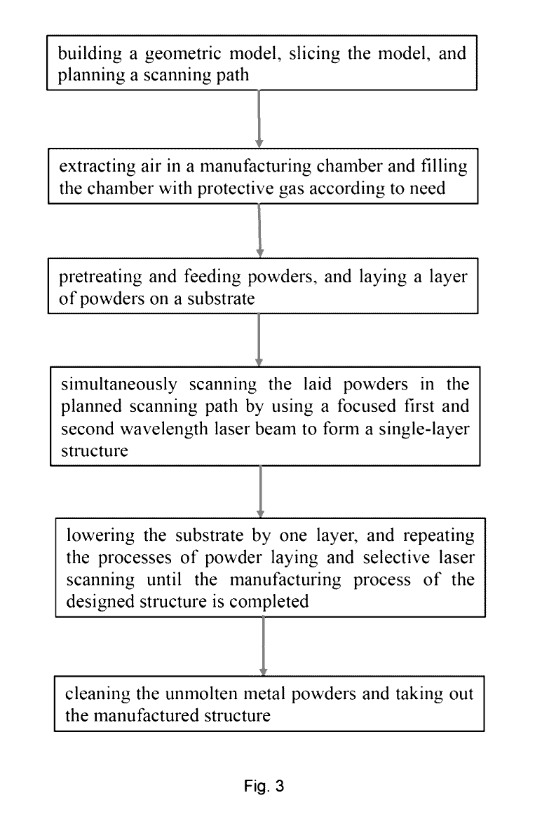

FIG. 3 is a flow chart of multi-wavelength selective laser rapid prototyping method according to the present invention, as shown in the figure, said method comprises the following:

1) building a geometric model by using a computer drawing software, slicing the model, and planning a scanning path;

2) extracting air in manufacturing chamber and filling the chamber with protective gas according to need;

3) preheating and feeding powders, by the powder feeding components, and laying a layer of powders on substrate by using the powder laying components;

4) simultaneously scanning the laid powders in planned scanning path by using the focused first and second wavelength laser beam so that powders are melted to form a single-layer structure;

5) lowering the substrate by one layer, and repeating the process of powder laying and selective laser scanning until the manufacturing process of the structure in designed geometric model is completed; and

6) cleaning the unmelted metal powders and taking out the manufactured structure.

The powder has a size from 10 nm to 200 μm.

The powders include metal powders, plastic powders, ceramic powders, coated sand powders, and polymer powders.

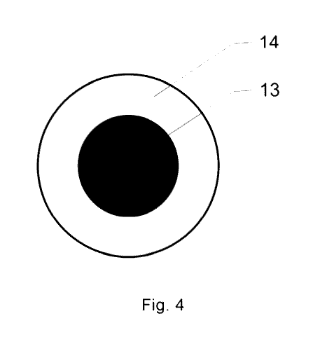

FIG. 4 is a schematic view of laser focal spots in the present invention. The focal spot 13 is the focus of the first wavelength laser beam having a wavelength of 200 nm to 1.1 μm. The focal spot 13 is the focus of the second wavelength laser beam having a wavelength of 700 nm to 10.6 μm, the first wavelength laser beam and the second wavelength laser beam are coaxially irradiated onto the manufacturing plane and are focused in the manufacturing plane. The laser focal spot 13 is smaller than the laser focal spot 14 in the manufacturing plane, and it is superimposed with and surrounded by the laser focal spot 14. The second wavelength laser beam who has the laser spot 14 is capable of achieving preheating and subsequent heat treatment of the powders, and in the superimposed region, together with the first wavelength laser beam having a wavelength of 200 nm to 1.1 μm causes the melting of the powders to form structure on the manufacturing plane.

### EXAMPLE 1

The present invention will now be described in detail with reference to FIGS. 1 and 3 by taking the multi-wavelength selective laser rapid prototyping of ZrO2-Al2O3 ceramic as an example. The selected ZrO2-Al2O3 ceramic powders are spherical powders having particle sizes from 30 μm to 60 μm.

Firstly, a geometric model of ceramic structure is built by using a computer drawing software, the model is sliced, and the scanning path is planned. The air in manufacturing chamber is then extracted. The pretreatment and feeding of powders are carried out by the powder feeding components 7. A layer of ceramic powders is laid on substrate 7 by using the powder laying components 8. The thickness of the laid monolayer ceramic powders is 60 μm. A 532 nm laser beam outputted by a green light laser source 1 with a laser power of 50-150 W is selected as the first wavelength laser beam; and a 10.6 μm laser beam outputted by a CO2 laser source 2 with a laser power of 140-400 W is selected as the second wavelength laser beam. The laid powders are simultaneously scanned, in planned scanning path with the focused first and second wavelength laser beam at a scanning speed of about 200 to 400 mm/s, so that the powders can melt to form a single layer structure. The morphology of the molten pool and the distribution of the temperature field during the manufacturing process are monitored by the real-time monitoring components 9.

The substrate 6 is lowered 60 μm by using the lifting components 10, and the powder laying and selective laser scanning process are repeated until, the manufacturing process of the ceramic structure in designed geometric model is completed. Then, the upper surface of the substrate 6 is raised to the initial position by using the lift component 10, and the unmelted ceramic powders are cleaned and the manufactured ceramic structure is taken out.

### EXAMPLE 2

The present invention will now be described in detail with reference to FIGS. 2 and 3 by taking the multi-wavelength selective laser rapid prototyping of titanium alloy as an example. The selected titanium alloy powders are spherical powders having particle sizes from 20 μm to 30 μm.

Firstly, a geometric, model of titanium alloy structure is built by using a computer drawing software, the model is sliced, and the scanning path is planned. The air in manufacturing chamber is then extracted and filled with argon as a protective gas. The pretreatment and feeding of powders are carried out by the powder feeding components 7. A layer of titanium alloy powders is laid on substrate 7 by using the powder laying components 8. The thickness of the laid monolayer titanium alloy powders is 50 μm. As shown in FIG. 2, a 532 nm laser beam outputted by the light laser source 1 with a laser power of 30-50 W is selected as the first wavelength laser beam; and a 1064 nm laser beam outputted by the light laser source 1 with a laser power of 150-200 W is selected as the second wavelength laser beam The laid powders are simultaneously scanned in planned scanning path with the focused first and second wavelength laser beam at a scanning speed of about 300 to 400 mm/s, so that the powders can melt to form a single layer structure. The morphology of the molten pool and the distribution of the temperature field during the manufacturing process are monitored by the real-time monitoring components 9.

The substrate 6 is lowered 50 μm by using the lifting components 10, and the powder laying and selective laser scanning process are repeated until, the manufacturing, process of the titanium alloy structure in designed geometric model is completed. Then, the upper surface of the substrate 6 is raised to the Initial position by using the lift component 10, and the unmelted titanium alloy powders are cleaned and the manufactured titanium alloy structure is taken out.

At last, it should be understood that the aforesaid preferred embodiments are merely to illustrate the invention and don't limit the scope of the invention. Although the invention has been described in detail, it should be appreciated the present invention may be modified in forms and details without departing from the scope Or spirit of the invention as defined by the appended claims.

What is claimed is:

1. A multi-wavelength selective laser rapid prototyping system, comprising:
laser light sources, laser transmission and control components, laser focusing and scanning components, manufacturing chamber, powder feeding components, powder laying components, gas circulation control components, real-time monitoring components, lifting components, powder recovery components, and computer, wherein:
said laser light source comprises a first laser source for providing a first wavelength laser beam and a second laser source for providing a second wavelength laser beam, or a laser source for providing both the first and second wavelength laser beams;
said laser the focusing and scanning components includes two laser focusing lenses for focusing the first wavelength laser beam and the second wavelength laser beam respectively, a dichroic mirror for combining the first wavelength laser beam and the second wavelength laser beam into a combined coaxial laser beam propagating in the same direction, and a two-dimensional galvanometer scanner for realizing laser scanning in a manufacturing plane;
said real-time monitoring components includes an imaging unit for monitoring the morphology of the molten pool and a temperature monitoring unit for monitoring the temperature and temperature field distribution of the molten pool.

2. The multi-wavelength selective laser rapid, prototyping system according to claim 1, wherein said wavelength range of the aforesaid first wavelength laser beam is from 200 nm to 1.1 μm, the wavelength range of the aforesaid second wavelength laser beam is from 700 nm to 10.6 μm; and the first wavelength laser beam and the second wavelength laser are continuous, pulsed or quasi-continuous laser.

3. The multi-wavelength selective laser rapid prototyping system according to claim 1, wherein said laser transmission and control components includes reflectors for changing laser beam direction, beam expanders for realizing the first and second wavelength laser beams expansion respectively, laser shutters and laser attenuators for controlling the power of the first wavelength laser beam and the second wavelength laser beam respectively.

4. The multi-wavelength selective laser rapid prototyping system according to claim 1, wherein said manufacturing chamber includes a chamber door for taking out manufactured structures, an observation window for visual observation, a light window for real-time monitoring, a laser incidence window for laser input, and a gas flow port for gas circulation and atmosphere control.

5. The multi-wavelength selective laser rapid prototyping system according to claim 4, wherein said a substrate is arranged in the aforesaid manufacturing chamber, and it is connected with the lifting components to realize the lifting movement the bottom of the manufacturing chamber is further provided with a channel for recovering the powder, wherein a port of the channel is connected with the powder recovery components.

6. The multi-wavelength selective laser rapid prototyping system according to claim 1, wherein said the imaging unit includes a CCD for image acquisition and a monitor for image presentation.

7. The multi-wavelength selective laser rapid prototyping system according to claim 1, wherein said the temperature monitoring unit comprises an infrared thermal imager for infrared thermal image acquisition and a data acquisition card for acquiring data of the thermal imager and inputting the data to the computer.

8. A multi-wavelength selective laser rapid prototyping method, comprising;
1) building a geometric model by rising a computer drawing software, slicing the model and planning the scanning path;
2) extracting air in manufacturing chamber and filling the chamber with protective gas according to need;
3) pretreating and feeding powders by the powder feeding components, and laying a layer of powders on substrate by using the powder laying components;
4) simultaneously scanning the laid powders in planned scanning path by using the focused first and second wavelength laser beam so that powders are melted to form a single-layer structure;
5) lowering the substrate by one layer, and repeating the process of powder laying and selective laser scanning until the manufacturing process of the structure in designed geometric model is completed; and
6) cleaning the unmelted metal powders and taking out the manufactured structure.

9. The multi-wavelength selective laser rapid prototyping method according to claim 8, wherein, said powder has a size from 10 nm to 200 μm.

10. The multi-wavelength selective laser rapid prototyping method according to claim 8, wherein said powders include metal powders, plastic powders, ceramic powders, coated sand powders, polymer powders.
